(19) United States
(12) Patent Application Publication
(10) Pub. No.: US 2008/0170505 A1
(43) Pub. Date: Jul. 17, 2008

(54) SYSTEMS AND METHODS FOR DATA OBSTRUCTION SYSTEM IDENTIFICATION AND CIRCUMVENTION

(76) Inventors: Thomas R. Rohlfing, Salt Lake City, UT (US); Fei Zhao, Provo, UT (US)

Correspondence Address: BAKER & ASSOCIATES PLLC, 470 EAST NINTH AVENUE, SALT LAKE CITY, UT, 84103, US

(21) Appl. No.: 11/971,529

(22) Filed: Jan. 9, 2008

Related U.S. Application Data
(60) Provisional application No. 60/884,967, filed on Jan. 15, 2007.

(51) Int. Cl. G06F 11/00

(52) U.S. Cl. 370/241

(57) ABSTRACT

The present invention relates to detecting, identifying, and circumventing data obstruction systems on a computer device including firewalls, filters, etc. One embodiment of the present invention relates to a video monitoring system control module method for identifying and circumventing active data obstruction systems to enable video monitoring data transmissions. The method includes transmitting a plurality of test data packets over communication ports corresponding to video monitoring system related communication protocols, so as to generate a receive thread key of blocked and transmitted test data packets. The receive thread key is correlated with data corresponding to known data obstruction systems in order to identify at least one data obstruction system. Video monitoring data is routed around the identified at least one known data obstruction system, thereby circumventing the known data obstruction systems. Circumvention of data may be accomplished by automatically disabling, automatically reconfiguring, and/or instructing a user to manually disable or reconfigure the corresponding data obstruction system.

### RELATED APPLICATIONS

This application claims priority to United States provisional application Ser. No. 60/884,967 filed Jan. 25, 2007, the contents of which are incorporated by reference.

### FIELD OF THE INVENTION

The invention relates to distributed data systems including video monitoring systems. In particular, the invention relates to systems and methods for identifying and circumventing data obstruction systems between components in a distributed data system.

### BACKGROUND OF THE INVENTION

Video monitoring systems are used to monitor video signals from one or more discrete locations or view angles. These systems are often used for security, surveillance, and personnel performance monitoring. Video monitoring systems generally include video capture devices, a control device, an optional storage device, and a display. The video capture devices are one or more cameras configured to record video data at particular discrete locations. The control device is a computer or electronic module that receives the video data from each of the video capture devices and routes the signal to the display. The storage device is a computer disk or other storage medium. The display converts the video data into a visually identifiable format. These components may be embedded into a multi-use personal computer or digital computer network, or they may incorporate portions of a computer network for purposes of data transmission and/or display.

One particular type of video monitoring system utilizes a multi-use control device such as a personal computer, multi-media center, PDA, phone, etc. The multi-use device includes a multi-use environment which allows users to perform various tasks, including those related and unrelated to the video monitoring system. Non-video monitoring tasks may include local tasks such as word processing and distributed tasks such as Internet browsing. Video monitoring system tasks include receiving video data from the video capture device and routing the video data to a display. Many multi-use devices include various forms of data obstruction systems that block certain data transmissions for various purposes. One type of data obstruction system is a firewall which obstructs incoming and outgoing data between a computer device and the Internet for security purposes. Likewise, a content filter is another data obstruction system which blocks user defined data transmissions. Unfortunately, these data obstruction systems often prevent or impede user-installed programs from transmitting and receiving necessary data for operation. The prevalence and rapidly-increasing aggressiveness of numerous unique data obstruction systems prevents programs from incorporating standardized circumvention systems.

Data obstruction systems generally include complex user interfaces designed to control and manage algorithms that attempt to block only undesired communications. However, these systems are not commonly understood or reconfigured by casual users. When a new user-installed program fails to operate due to a pre-installed data obstruction system, the user often erroneously assumes the newly installed program is defective and/or does not wish to attempt to research the necessary reconfiguration strategy that will enable circumvention of the data obstruction system. This results in customer dissatisfaction with the newly installed program.

Therefore, there is a need in the networked-application industry for systems and methods that would enable the identification and/or circumvention of the particular data obstruction system(s) that obstruct the desired data transmissions.

### SUMMARY OF THE INVENTION

The present invention relates to detecting, identifying, and circumventing data obstruction systems on a computer device including firewalls, filters, etc. One embodiment of the present invention relates to a video monitoring system control module method for identifying and circumventing active data obstruction systems to enable video monitoring data transmissions. The method includes transmitting a plurality of test data packets over communication ports which are used by the application, and, and which correspond to video monitoring system related communication protocols, so as to generate a receive thread key to determine whether the transmitted test data packets are received or not.. The results from the receive thread key are correlated with specific, data known to correspond with identified data obstruction systems in order to identify at least one potentially active data obstruction system. Video monitoring data is routed around the identified at least one known data obstruction system, thereby circumventing the known data obstruction systems. Circumvention of data may be accomplished by automatically disabling, automatically reconfiguring, and/or instructing a user to manually disable or reconfigure the corresponding data obstruction system. A second embodiment of the present invention relates to a computer controlled video monitoring system disposed within a multi-use computing and communication system including a data obstruction circumvention module.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The following description of the invention can be understood in light of the Figures, which illustrate specific aspects of the invention and are a part of the specification. Together with the following description, the Figures demonstrate and explain the principles of the invention. The Figures presented in conjunction with this description are views of only particular-rather than complete-portions of the systems and methods of making and using the system according to the invention. In the Figures, the physical dimensions may be exaggerated for clarity.

FIG. 1 illustrates a flow chart of a suitable computer operating environment for embodiments of the present invention;

FIG. 2 illustrates a schematic view of a computer controlled distributed multiple video monitoring system including a graphical functional representation of a data obstruction system in accordance with embodiments of the present invention;

FIG. 3 illustrates a flow chart of a method for identifying and circumventing data obstruction systems on a video monitoring control module disposed on a multi-use computing system in accordance with embodiments of the present invention; and

FIG. 4 illustrates a detailed flow chart of one embodiment of a process for identifying and circumventing a data obstruction system in accordance with embodiments of the present invention.

### DETAILED DESCRIPTION OF THE INVENTION

The present invention relates to detecting, identifying, and circumventing data obstruction systems on a computer device including firewalls, filters, etc. One embodiment of the present invention relates to a video monitoring system control module method for identifying and circumventing active data obstruction systems to enable video monitoring data transmissions. The method includes transmitting a plurality of test data packets over communication ports corresponding to video monitoring system related communication protocols, so as to generate a receive thread key of received test data packets. This received packet data is compared to what was transmitted, to determine what kinds of network traffic were blocked. If any data packets were blocked, then the computer device is scanned to look for known blocking programs which are running on the computer. The receive thread key is correlated with data corresponding to known data obstruction systems in order to identify at least one data obstruction system. Video monitoring data is routed around the identified at least one known data obstruction system, thereby circumventing the known data obstruction systems. Circumvention of data may be accomplished by automatically disabling, automatically reconfiguring, and/or instructing a user to manually disable or reconfigure the corresponding data obstruction system. A second embodiment of the present invention relates to a computer controlled video monitoring system disposed within a multi-use computing and communication system including a data obstruction circumvention module. While embodiments of present invention are described in reference to systems and methods for identifying and circumventing data obstruction systems to enable the operation of a video monitoring system, it will be appreciated that the teachings of present invention are applicable to other areas.

The following terms are defined as follows:

Data obstruction systems—a system or process configured to block or impede select data transmissions, including but not limited to firewalls, content filters, virus scans, privacy services, spam filters, etc.

Control module—a computer and/or electrical component for receiving, transmitting, displaying multi-location data, including video data or other digital data, controlling video devices, and facilitating communication with attached video devices. The control module may also be coupled to one or more client modules to facilitate distributed video monitoring system related functionality. The client modules may be data coupled locally or remotely. [do we want to be so specific about video?]

Video monitoring system—a system for location-based video monitoring for purposes including surveillance, monitoring, and personnel performance. The system includes at least one video capture device and a control module.

Local data transmission system—a data transmission system for transferring data between components within a confined region, for example a local Ethernet, power line computer network, wireless network, or analog or digital wired or wireless transmission systems.

Multi-use computing environment—an operating environment of a computing system that may be utilized for a variety of independent and/or simultaneous tasks/applications. For example, a computer device such as a personal desktop computer includes an operating system environment which may simultaneously perform various tasks, including controlling a video monitoring system and operating a word processing application. Various other systems may also be referred to as including a multi-use computing environment including but not limited to a cell phone, a PDA, a laptop, a multi-media player, etc.

The following disclosure of the present invention is grouped into two subheadings, namely “Operating Environment” and “Data Obstruction System Identification and Circumvention”. The utilization of the subheadings is for convenience of the reader only and is not to be construed as limiting in any sense.

### Operating Environment

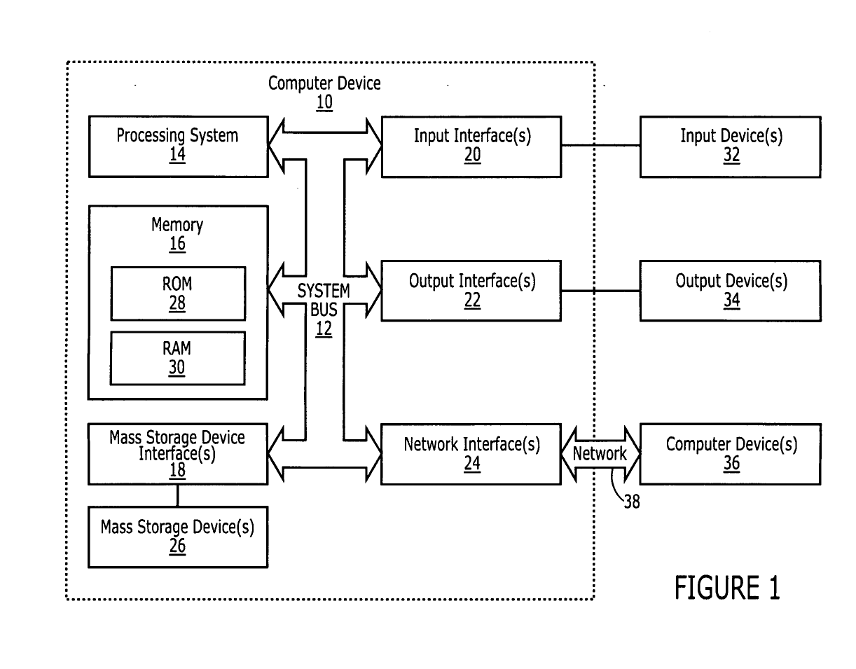

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration. Alternatively, the invention may also be practiced in whole or in part manually following the same procedures.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”), smart phone, or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

### Data Obstruction System Identification and Circumvention

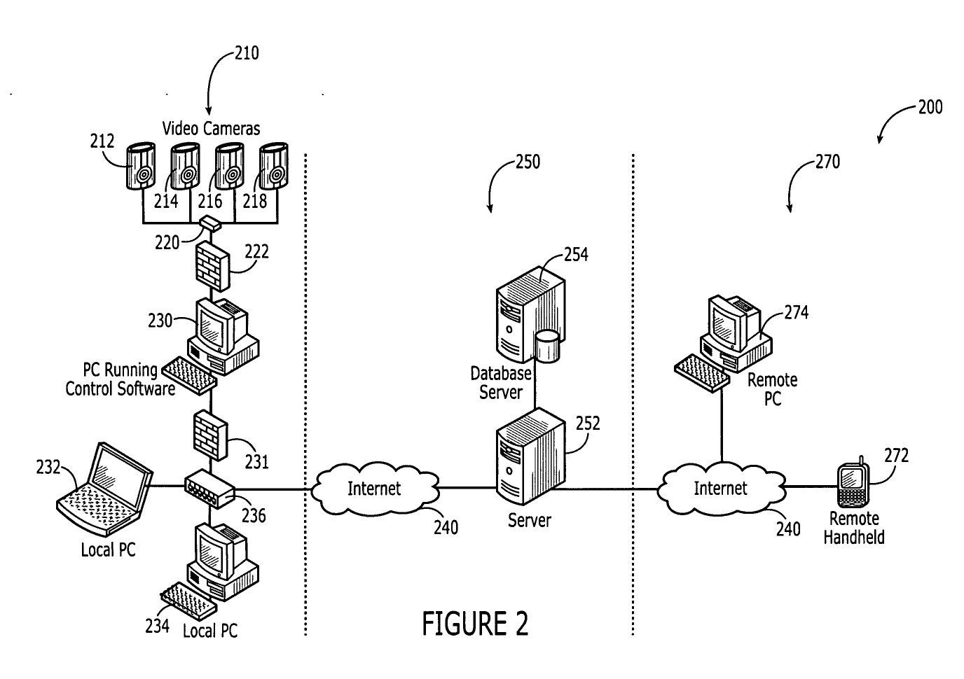

Reference is next made to FIG. 2, which illustrates a schematic view of a computer controlled distributed multiple video monitoring system (again, should it be more general to cover other networked distributed data systems?), designated generally at 200. The illustrated system 200 architecture is an example of one type of video monitoring system in which embodiments of the present invention may be utilized. Various components of the illustrated system will be further described for purposes of reference to the embodiments of the present invention. It will be appreciated that embodiments of the present invention may be utilized with other alternative distributed video monitoring system architectures. The illustrated system 200 includes a local computer controlled video monitoring/surveillance system 210, a distributed data processing system 250, and a remote client system 270. The systems 210, 250, 270 are coupled via the Internet 240 acting as a global data transmission system. They may also be coupled via a local net or LAN, or other network arrangement. As is well known in the industry, various components may be further distributed or geographically consolidated for purposes of utilizing hardware and/or data coupling resources.

The computer controlled video monitoring system 210 includes a plurality of video capture devices 212, 214, 216, 218, a video router 220, a control module 230, a local laptop client 232, a local PC client 234, and a local network router 236. The video capture devices 212, 214, 216, 218 are digital video cameras configured to capture video data of a particular location and generate a video data signal that includes graphical sequential images of the particular location. One type of digital video capture device is a WILIFE® brand camera. The video capture devices 212, 214, 216, 218 are data coupled to the control module 230 via. The video router 220 is an optional component and may be any type of data converter, multiplexer, or router such as a USB power line data converter or Ethernet data converter. For example, the video capture devices 212, 214, 216, 218 may be coupled to a power line network such as a HOMEPLUG type system in which a USB or Ethernet powerline bridge allows the control module 230 to receive the video data signal from all of the video capture devices 212, 214, 216, 218 across the power line. The video capture devices 212, 214, 216, 218 may comprise a variety of different types of devices including but not limited to analog, digital, wireless, wired, panable, fixed, indoor, outdoor, discrete, spy, mobile, etc. The control module 230 is a multi-use personal computer running a software module configured to receive and process the video data signals from the video capture devices 212, 214, 216, 218. For example, the software module may be a WILIFE® brand program. The control module 230 may perform other tasks in addition to managing the video data signals utilizing a well known multiprocessing operating system such as Microsoft WINDOWS®. The control module 230 may be configured to record, display, alert, or transmit data corresponding to the video data signals from the video capture devices 212, 214, 216, 218. The local laptop client 232 and local PC client 234 are data coupled to control module 230 via an optional network router 236 such as an Ethernet wired router or wireless 802.11 type data router. Various other local network architectures may be utilized to distribute the video data signals among the local clients 232, 234 and between the video capture devices 212, 214, 216, 218, and the control module 230.

The computer controlled video monitoring system 210 is coupled to the distributed data processing system 250 via the Internet 240. The distributed data processing system 250 includes a database server 254 and a server 252. The database server 254 may be configured to store video data from one or more computer-controlled video monitoring systems 210, authentication information, account information, etc. The server 252 may be used to facilitate routing video data from the computer controlled video monitoring system 210 to the remote client system 270. For example, the illustrated server 252 and database server 254 may authenticate a user on the remote client system 270 and transmit the appropriate one or more requested video data signals from the corresponding computer controlled video monitoring system 210. Various other management and storage type functions may be performed by the distributed data processing system 250. In an alternative data processing configuration, data signals from the computer controlled video monitoring system 210 may be routed directly to the remote client system 270 without the data processing system 250. Depending on various communication parameters, the use of intermediary data routing, authentication, and/or processing through the distributed data processing system 250 is optional.

The remote client system 270 includes a remote client pc 274 and a remote client handheld 272, both data coupled to the Internet 240. The remote clients 272, 274 may display one or more video data signals from the video capture devices 212, 214, 216, 218 of the computer controlled video monitoring system 210. In particular, the remote clients 272, 274 may select to view the multiple video data signals individually, simultaneously, or intermittently. The remote clients 272, 274 may also interface with the distributed data processing system 250 for purposes of authentication, data routing, electronic payment, management, etc. The remote clients 272, 274 may be coupled to the Internet 240 utilizing various well known connection schemes including but not limited to cellular phone data networks, local computing data networks, etc. The remote clients 272, 274 may interface and/or receive the video data signals from a web browser or directly within a particular local software module. Likewise, the remote clients 272, 274 may receive email attachments corresponding to data from the computer controlled video monitoring system 210.

A data obstruction system disposed on the control module 230 is functionally represented by two walls 222, 231 positioned on the schematic diagram between elements to indicate one example of a data blocking scheme. The data obstruction system may block one or more communication ports, types of data packets, sized data packets, etc. depending on the configuration of the particular data obstruction system. It will be appreciated that the data obstruction system may be any type of data blocking software module or process including but not limited to one or more of a firewall, filter, virus, and/or user implemented censorship module. The first wall 222 is disposed between the control module 230 and the video router 220, indicating that the video data signals from the video capture devices may be blocked by the data obstruction system. The second wall 231 is disposed between the control module 230 and the firewall 216 so as to indicate obstructing certain data from being transmitted to and from the control device 214. The data obstruction system may also obstruct video monitoring data from the plurality of cameras 212 transmitted to local and remote PCs 220, 222, 258, 260, thereby preventing distributed operation of the video monitoring system. In addition, the data obstruction system may prevent the control module 230 from receiving updates and/or control requests from the servers 252, 254. Various other functionalities and characteristics of the data monitoring system may be directly or indirectly affected or impeded by the data obstruction system. It is therefore necessary for the video monitoring system to identify and circumvent any active data obstruction systems to enable proper video monitoring system operation.

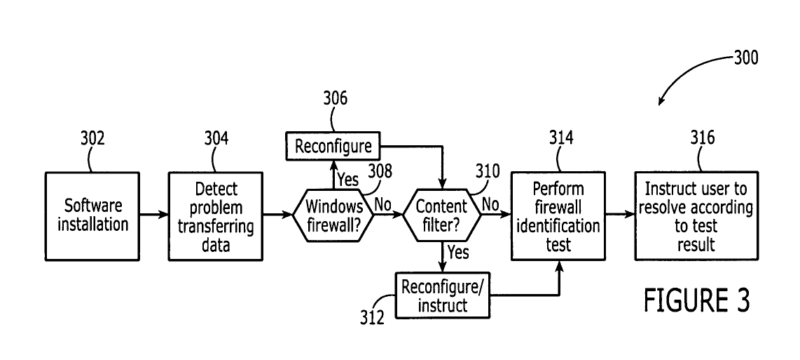

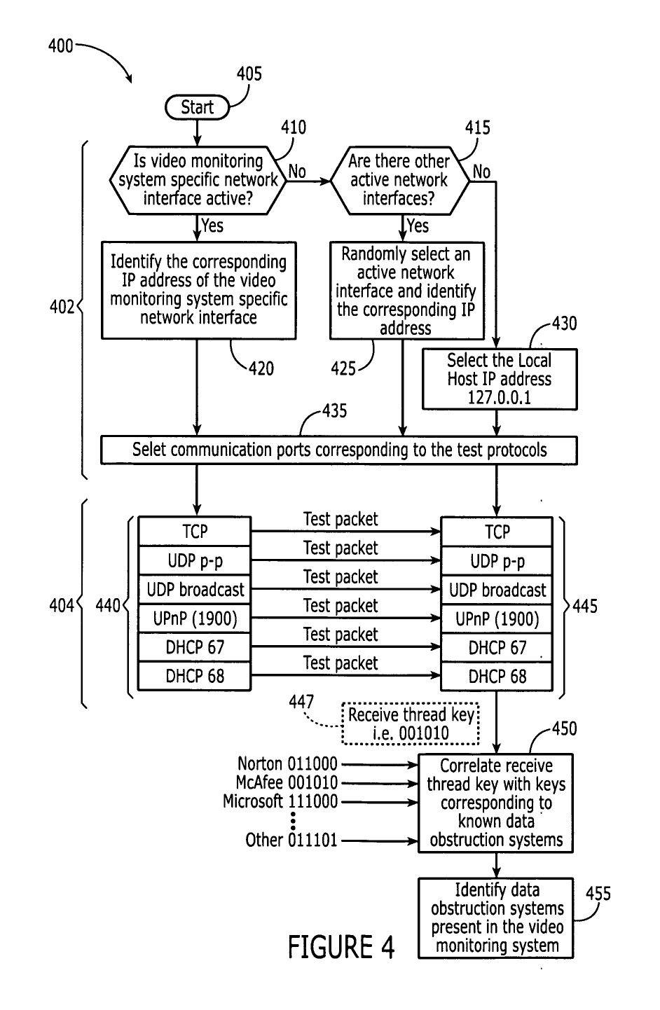

Reference is next made to FIG. 3, which illustrates a flow chart of a method for identifying and circumventing data obstruction systems on a video monitoring control module disposed on a multi-use computing system, in accordance with one embodiment of the present invention, designated generally at 300. The method includes installing the particular software which requires data communications, act 302. A problem transmitting data is detected, act 304. Data transmission problems may be detected from a variety of events including but not limited improper system functionality, inability to receive video signals, inability to transmit video monitoring data to client modules, etc. The presence of the Windows operating system firewall is determined, act 308 and automatically or manually reconfigured if present, act 306. The Windows operating system firewall is commonly installed and active on all Windows-based multi-use computing systems. Alternatively, other operating system based firewalls may similarly be detected and reconfigured in accordance with the teachings of the present invention. The presence of a content filter is determined, act 310 and reconfigured if present, act 312. A content filter is any type of filter designed to obstruct particular content from being transmitted or received including but not limited to an adult content filter, offensive content filter, confidential content filter, etc. Operating system firewalls and content filters are often able to be automatically reconfigured to allow for proper routing of video monitoring system data. The reconfiguration of these obstruction systems often involve adding/configuring an exception and/or allowing for unobstructed data transmission over a particular communication port. A firewall identification test (data obstruction system identification test) is then performed that identifies the particular firewalls present in the system upon which the software is being installed, act 314. One embodiment of a suitable data obstruction system identification test is included in the methodology illustrated and described with reference to FIG. 4. The method then displays a set of instructions that will resolve the identified firewalls/data obstruction systems, act 316. It should be noted that the acts of identifying the windows firewall, the content filter, and other data obstruction systems may also be incorporated within the act of performing the data obstruction system identification test. In addition, the method may include automatically reconfiguring the identified data obstruction systems rather than or in addition to instructing a user on how to reconfigure the identified data obstruction systems. The method of identifying and circumventing is often performed during the installation process of a video monitoring system but may also be performed during operation if data is subsequently obstructed.

Reference is next made to FIG. 4, which illustrates a detailed flow chart of one embodiment of a process for identifying and circumventing a data obstruction system, designated generally at 400. The process includes an initial step of systematically selecting an active network interface and communication ports across which to transmit the test data packets, step 402. The network interface is systematically selected based on availability and applicability to video monitoring. The communication ports are selected based on relationships to corresponding video monitoring system communication protocols. The step of selecting appropriate communication ports, step 402, includes a plurality of systematic decision based acts. Initially, it is determined if a specific video monitoring system specific network interface is active, act 410. If the specific video monitoring system specific network interface is active, the corresponding IP address is identified, act 420. If the specific video monitoring system specific network interface is not active (or blocked by the data obstruction system), a determination is made as to if there are other active network interfaces, act 415. If there are other active network interfaces, an active network interface is randomly selected and it's corresponding IP address is identified, act 425. If there are no other active network interfaces, the Local Host IP address 127.0.0.1 is selected, act 430. The communication ports are then selected based on the necessary corresponding protocols for the video monitoring system, act 435.

The process then includes a general step of generating a receive thread key 447 based on the transmission and receipt of a test thread including multiple test data packets, step 404. The general step 404 includes various acts including generating a send thread 440 including test data packets positioned on corresponding communication ports and the selected network interface. The send thread 440 is then routed through a data feedback loop consisting of the selected active network interface IP address so as to be able to test the results of the transmitted send thread 440. A receive thread 445 is then received via the data feedback loop including any non-blocked transmitted test data packets that were successfully transmitted through the data obstruction system. The receive thread key 447 is then generated based on correlating which test data packets were successfully received in the receive thread 445, thereby creating a unique key of Boolean block/non-block operators indicating which of the test data packets were obstructed by the data obstruction system. A test data packet may be deemed to be successfully received if its contents in the receive thread 445 are substantially identical/consistent to that transmitted in the send thread 440. The receive thread key 447 is correlated with keys corresponding to known data obstruction systems, act 450. The correlation may further include various mathematical comparative algorithmic and/or comparative methodologies to identify the active data obstruction system(s). It will be appreciated that the process of identifying multiple data obstruction systems may include various repetitive processes so as to isolate the characteristics of each of the data obstruction systems. The process then includes identifying the active data obstruction systems present in the video monitoring system and/or computer operating environment, act 455. Embodiments of the present invention include utilizing a multi-use computing system of the control module of the video monitoring system, and therefore various data obstruction systems may be present based on the non-video monitoring related tasks performed on the multi-use computing system.

Various other embodiments have been contemplated, including combinations in whole or in part of the embodiments described above.

What is claimed is:

1. A video monitoring system control module software method for identifying and circumventing active data obstruction systems to enable video monitoring data transmissions comprising the acts of:
transmitting a plurality of test data packets over a network interface and a plurality of communication ports, wherein the plurality of communication ports correspond to video monitoring system related communication protocols, and wherein the network interface is selected so as to facilitate a data feedback loop;
generating a receive thread key of blocked and transmitted test data packets;
providing a set of keys corresponding to known data obstruction systems;
correlating the receive thread key with the set of keys corresponding to known data obstruction systems;
identifying at least one active data obstruction system; and
circumventing data on the plurality of communication ports around the identified at least one data obstruction system.

2. The method of claim 1 further includes selecting a plurality of communication ports and an active network interface for transmission and receipt of the test data packets.

3. The method of claim 2, wherein the act of selecting a plurality of communication ports and a network interface for transmission and receipt of the test data packets further comprising the acts of:
determining if a video monitoring system specific network interface is active;
if the video monitoring system specific network interface is active, identifying the corresponding IP address of the video monitoring specific network interface;
if the video monitoring system specific network interface is blocked, determining if there are other active network interfaces;
if there are no other active network interfaces, selecting the local host IP address;
if there are other active network interfaces, randomly selecting an active network interface and identifying the corresponding IP address; and
selecting the communication ports corresponding to the video monitoring system related protocols.

4. The method of claim 1, wherein the act of transmitting a plurality of test data packets over a network interface and a plurality of communication ports includes generating a send thread comprising a plurality of test data packets on corresponding video monitoring system related communication protocols and positioned on an active network interface.

5. The method of claim 4, wherein the video monitoring system related communication protocols include at least one of TCP, UDP point-to-point, UDP Broadcast, UPnP, and DHCP.

6. The method of claim 1, wherein the act of generating a receive thread key of blocked and transmitted test data packets includes receiving a receive thread including a set of received test data packets, identifying the communication ports on which test packets are blocked and transmitted, generating a receive thread key corresponding to the communication ports indicating whether the test data packet is blocked or transmitted for each of the plurality of communication ports.

7. The method of claim 1, wherein the act of providing a set of keys corresponding to known data obstruction systems includes providing a key for each known data obstruction system including an indication as to whether a test packet is blocked or transmitted for each of the plurality of communication ports.

8. The method of claim 1, wherein the act of correlating the receive thread key with the set of keys corresponding to known data obstruction systems includes applying comparative mathematical relational analysis between the receive thread key and the keys corresponding to known data obstruction systems.

9. The method of claim 1, wherein the act of identifying at least one active data obstruction system includes if the receive thread key is identical to the key of a particular key corresponding to a known data obstruction system, identifying the particular known data obstruction system.

10. The method of claim 1, wherein the act of circumventing data on the plurality of communication ports around the identified at least one data obstruction system includes at least one of disabling the identified at least one data obstruction system, reconfiguring the identified at least one data obstruction system, displaying instructions to reconfigure the identified at least one data obstruction system, and displaying instructions to disable the identified at least one data obstruction system.

11. The method of claim 1 further includes identifying the presence of an operating system based firewall on a control module of the network video monitoring system and reconfiguring the operating system based firewall to enable video monitoring system data transmission.

12. The method of claim 1 further including detecting the presence of a content filter on a control module of the network video monitoring system and performing at least one of reconfiguring the detected content filter to enable the operation of the video monitoring system, and displaying instructions for a user to reconfigure the detected content filter.

13. A method for identifying and circumventing active data obstruction systems to enable data transmissions comprising the acts of:
transmitting a plurality of test data packets over a network interface and a plurality of communication ports, wherein the plurality of communication ports correspond to communication protocols, and wherein the network interface is selected so as to facilitate a data feedback loop;
generating a receive thread key of blocked and transmitted test data packets;
providing a set of keys corresponding to known data obstruction systems; correlating the receive thread key with the set of keys corresponding to known data obstruction systems;
identifying at least one active data obstruction system; and
circumventing data on the plurality of communication ports around the identified at least one data obstruction system.

14. A computer controlled video monitoring system disposed within a multi-use computing and communication system, comprising:
a local data transmission system;
a video input source, wherein the video input source includes a video capture device configured to create a video data signal, and wherein the video input source is coupled to the local data transmission system;
a control module data coupled to the video input source via the local data transmission system so as to receive the video data signal, wherein the video data signal is received and transmitted over a plurality of communication ports utilizing video monitoring communication protocols, and wherein the control module is disposed within a multi-use computing environment;
at least one data obstruction system disposed within the multi-use computing environment and configured to block the transmission of video monitoring data over at least one communication port;
wherein the control module further includes a data obstruction circumvention module, wherein the data obstruction circumvention module includes a data feedback loop configured to transmit and receive at least one test thread including a plurality of test data packets disposed on communication ports corresponding to the video monitoring communication protocols, and wherein the data obstruction resolution module further includes:
a correlation module configured to correlate the received test thread with data corresponding to the blocking characteristics of known data obstruction systems; and
an identification module configured to identify data active obstruction systems present in the multi-use computing environment.

15. The system of claim 14, wherein the data feedback loop includes an active network interface systematically selected based on availability and applicability to video monitoring.

16. The system of claim 14, wherein the at least one data obstruction system includes firewalls, spam filters, content filters, and operating system firewalls.

17. The system of claim 14, wherein the video monitoring communication protocols include at least one of TCP, UDP, UDP broadcast, UDP point-to-point, UPnP, and DHCP.

18. The system of claim 14, wherein the control module further includes a resolution module configured to circumvent video monitoring data around the at least one data obstruction system including at least one of disabling the at least one data obstruction system, reconfiguring the at least one data obstruction system, displaying instructions to reconfigure the at least one data obstruction system, and displaying instructions to disable the at least one data obstruction system.

19. The system of claim 14, wherein the at least one data obstruction system is configured to block the video data signal received via the local data transmission system.

20. The system of claim 14, wherein the computer controlled video monitoring system further includes at least one client module data coupled to the control module to display video monitoring data, and wherein the at least one data obstruction system is configured to block the data coupling between the control module and the at least one client module.
